(19) United States
(12) Patent Application Publication
(10) Pub. No.: US 2026/0019029 A1
(43) Pub. Date: Jan. 15, 2026

(54) INTERNALLY DISPOSED ATTACHMENT MECHANISMS FOR MOUNTING SOLAR PANEL MODULES AND METHODS OF INSTALLATION THEREFOR

(71) Applicant: Unirac, Inc., Albuquerque, NM (US)

(72) Inventor: Todd Ganshaw, Albuquerque, NM (US)

(21) Appl. No.: 19/263,896

(22) Filed: Jul. 9, 2025

Related U.S. Application Data
(60) Provisional application No. 63/670,441, filed on Jul. 12, 2024.

(51) Int. Cl. H02S 30/10

(52) U.S. Cl. CPC H02S 30/10

(57) ABSTRACT

An attachment mechanism secures a solar panel module to a surface. The attachment mechanism includes a spacer having a channel and a fastener. The fastener has a first portion with first threads, where the first portion is at least partially disposed through the channel. The first threads are at least partially disposed into the surface for securing the spacer and the fastener to the surface. The fastener has a second portion with second threads different than the first threads. The second portion is disposed at least partially through a through hole of the solar panel module. A nut of the attachment mechanism is engaged with the second threads to secure the solar panel module to the fastener.

### CROSS-REFERENCE TO RELATED APPLICATIONS

This application claims priority to U.S. Provisional Patent Application No. 63/670,441, filed Jul. 12, 2024, entitled “Internally Disposed Attachment Mechanisms for Mounting Solar Panel Module and Methods of Installation Thereof,” the entirety of which is herein incorporated by reference.

### BACKGROUND

The solar industry is growing worldwide and, as a result, more efficient structures are desirable for mounting photovoltaic modules or solar panel modules to a surface, such as a roof of a home or other building. In addition, structures that mount solar panel modules to a surface are often aesthetically unappealing. Conventional structures are also often secured to a frame or perimeter of the solar panel modules. However, these types of structures may not be usable with modern solar panel modules.

### BRIEF DESCRIPTION OF THE DRAWINGS

FIG. 1 illustrates an isometric exploded view of an example attachment mechanism that secures a solar panel module to a surface, according to an embodiment of the present disclosure.

FIG. 2 illustrates an example sequence to secure a solar panel module to a surface using the attachment mechanism of FIG. 1, according to an embodiment of the present disclosure.

FIG. 3 illustrates a cross-sectional view of the attachment mechanism and the solar panel module of FIG. 1, taken along line A-A of FIG. 2, according to an embodiment of the present disclosure.

FIG. 4 illustrates a side view of an example fastener of the attachment mechanism of FIG. 1, according to an embodiment of the present disclosure.

FIG. 5 illustrates an example fastener that may be usable with the attachment mechanism of FIG. 1, according to an embodiment of the present disclosure.

FIG. 6 illustrates a side view of an example spacer of the attachment mechanism of FIG. 1, according to embodiments of the present disclosure.

FIG. 7 illustrates an end view of the spacer of FIG. 6, according to an embodiment of the present disclosure.

FIG. 8 illustrates an example sequence to secure the fastener of FIG. 4 and the spacer of FIG. 6 to a surface, according to an embodiment of the present disclosure.

FIG. 9 illustrates a side view of an example attachment mechanism to secure a solar panel module to a surface, according to an embodiment of the present disclosure.

FIG. 10 illustrates an isometric view of an example spacer of the attachment mechanism of FIG. 9, according to an embodiment of the present disclosure.

FIG. 11 illustrates a cross-sectional view of the spacer of FIG. 10 secured to a solar panel module, taken along line B-B of FIG. 9, according to an embodiment of the present disclosure.

FIG. 12 illustrates an isometric view of an example spacer that may be usable with the attachment mechanism of FIG. 9, according to an embodiment of the present disclosure.

FIG. 13 illustrates an isometric view of an example spacer that may be usable with the attachment mechanism of FIG. 9, according to an embodiment of the present disclosure.

FIG. 14 illustrates a side view of an example attachment mechanism to secure a solar panel module to a surface, according to an embodiment of the present disclosure.

FIG. 15 illustrates an isometric view of an example spacer of the attachment mechanism of FIG. 14, according to an embodiment of the present disclosure.

FIG. 16 illustrates a cross-sectional view of the attachment mechanism of FIG. 14 secured to a solar panel module, taken along line C-C of FIG. 14, according to an embodiment of the present disclosure.

FIG. 17 illustrates an isometric view of an example spacer that may be usable with the attachment mechanism of FIG. 14, according to an embodiment of the present disclosure.

FIG. 18 illustrates an isometric exploded view of an example attachment mechanism to secure a solar panel module to a surface, according to an embodiment of the present disclosure.

FIG. 19 illustrates an example sequence to secure the attachment mechanism and the solar panel module of FIG. 18 to a surface, according to an embodiment of the present disclosure.

FIG. 20 illustrates a cross-sectional view of the attachment mechanism and the solar panel module of FIG. 18, taken along line D-D of FIG. 19, according to an embodiment of the present disclosure.

FIG. 21 illustrates a first side view of an example attachment mechanism to secure a solar panel module to a surface, according to an embodiment of the present disclosure.

FIG. 22 illustrates a top view of the attachment mechanism of FIG. 21, according to an embodiment of the present disclosure.

FIG. 23 illustrates a second side view of the attachment mechanism of FIG. 21, according to an embodiment of the present disclosure.

FIG. 24 illustrates an exploded view of the attachment mechanism of FIG. 21, according to an embodiment of the present disclosure.

FIG. 25 illustrates an example process to secure a solar panel module to a surface, according to an embodiment of the present disclosure.

FIG. 26 illustrates an example process to secure attachments to a solar panel module, according to an embodiment of the present disclosure.

### DETAILED DESCRIPTION

This application is directed, at least in part, to an attachment mechanism that secures one or more solar panel modules to a surface, such as a roof, according to embodiments of the present disclosure. In an embodiment, the attachment mechanism may secure to the solar panel module, or a frame thereof, at a location inside a perimeter of the solar panel module. For example, one or more through holes may be disposed through glass, encapsulants, solar cells, etc., of the solar panel module. In an embodiment, the attachment mechanism may include a spacer that disposes (e.g., spaces) the solar panel module above the surface, and a fastener disposed through the through holes of the solar panel module as well as a channel of the spacer. The fastener may be fastened into the surface to secure the solar panel module to the surface. In an embodiment, a portion of the attachment mechanism, such as the spacer, may be secured to the solar panel module before installation of the solar panel module to the surface. Alternatively, the spacer may be separately secured to the surface and thereafter, the solar panel module may be secured to the spacer. The use of the attachment mechanism may reduce installation times and complexities, and/or times and complexities associated with repairing the solar panel module.

The fastener of the attachment mechanism may include any suitable fastener, such as a bolt, screw, etc. In an embodiment, the fastener may represent a hanger bolt having first threads (e.g., self-tapping lag threads) disposed along a first length of the fastener and/or second threads (e.g., machined threads) disposed along a second length of the fastener. The second threads may be different than the first threads. The first threads may be secured into a deck, rafter, stud, etc., of the surface (e.g., roof). A nut may thread onto the second threads. In an embodiment, a socket may be engaged with the nut and used to drive the fastener into the surface. Moreover, once driven into the surface, a portion of the second length (e.g., the second threads) may be disposed above the surface. As will be explained herein, the portion of the second threads disposed above the surface may receive the solar panel module. For example, the solar panel module may be disposed onto a length of the fastener corresponding to the second threads.

In an embodiment, the fastener, when embodied as a hanger bolt, may be a headless hanger bolt or a headed hanger bolt. Additionally, the threads of the fastener may be right-handed thread and/or left-handed thread. In an embodiment, the first threads may be right-handed, and the second threads may be left-handed, or vice versa. In doing so, the fastener may avoid backing out as the nut is loosened from the second threads.

The spacer (e.g., grommet, bushing, standoff, attachment, apparatus, device, etc.) may include the channel through which a portion of the fastener is disposed. For example, the first threads may be at least partially disposed through the channel and secured into the surface. In an embodiment, a seal (e.g., gasket, washer, grommet, etc.) may be disposed between the spacer and the surface to prevent an ingress of liquid, debris, etc., into a penetration in the surface created by the fastener. In such instances, the fastener may be disposed through the seal.

The seal may be manufactured from rubber (e.g., butyl), silicone, neoprene, etc., to provide a water-tight seal against the surface and prevent an ingress of liquid. Additionally, or alternatively, in an embodiment, the spacer may be made of a material that provides a water-tight seal against the surface. In such instances, the spacer may be manufactured from rubber, for example. Additionally, or alternatively, caulk, epoxies, etc., may be used to seal the spacer (or the seal) against the surface. For example, the spacer may include a counterbore (e.g., cavity, pocket, groove, etc.) in which a sealant (e.g., liquid butyl) is disposed for sealing the spacer against the surface. In this example, the sealant may be disposed in the counterbore prior to securing the spacer to the surface. As the fastener is driven into the surface, the sealant may be drawn into the surface to seal penetrations caused by the fastener. In addition, the sealant may seal around the fastener.

As introduced above, once the fastener and the spacer are secured to the surface, a through hole of the solar panel module may be disposed over/onto the fastener (e.g., an end opposite that is secured to the surface). A portion of the fastener that includes the second threads may protrude through the solar panel module (via the through hole) and a nut may be fastened onto the second threads. In an embodiment, a bottom surface of the solar panel module (or a frame thereof) may rest or abut against the spacer, thereby disposing the solar panel module above the surface. The nut is disposed against the top surface of the solar panel module. When the nut is tightened onto the second threads, the solar panel module may be secured to the surface.

Any number of the attachment mechanisms may be used to secure the solar panel module to the surface. For example, the solar panel module may include a plurality of the through holes (e.g., four, ten, etc.), and a plurality of the fasteners (e.g., four, ten, etc.) may be secured into the surface for securing the solar panel module to the surface. The through holes, as discussed herein, may be apertures, holes, channels, passages, etc., disposed through the solar panel module (e.g., between a top and a bottom) at a location within, inside, etc., a perimeter of the solar panel module and/or solar cells of the solar panel module. The through holes may be sized to receive the fasteners. The through holes may be located inside the perimeter by any distance, may be arranged in any pattern, may be spaced apart from one another by any spacing, etc. Although the through holes are described as being located inside the perimeter of the solar panel module, the through holes may be located differently. For example, the through holes may be disposed external to one or more solar cells of the solar panel module (e.g., between adjacent solar cells of the solar panel module), but may be located internal to a frame or perimeter of the solar panel module.

In an embodiment, the spacers may be used without the fasteners. For example, a subset or portion of the spacers may be located at different positions than the fasteners to reduce the flexure of the solar panel module associated with snow loads, wind loads, etc. As such, in an embodiment, a different number of the spacers may be secured to the solar panel module as compared to a number of the fasteners used to secure the solar panel module to the surface. The spacers may attach to the solar panel module to space the solar panel module above the surface and provide support against the surface from various loads. However, the fasteners may not be disposed through these spacers.

In an embodiment, the solar panel module may be removed from the surface for repair, maintenance, etc., and in such instances, the spacer and the fastener may remain secured to the surface. For example, the nut may be unthreaded from the fastener (e.g., the second threads). The solar panel module may be removed, for example, by lifting the solar panel module off the fasteners. The fasteners and the spacer, however, are kept in position on the surface. This facilitates installation after the solar panel module has been repaired, for example. Moreover, having the fasteners and the spacers remain secured to the surface avoids compromising, breaking, etc., the integrity of the seal between the attachment mechanism and the surface. However, in an embodiment, the spacer may be removed with the solar panel module, or during a removal of the solar panel module, and thereafter, the spacer may be resecured to the surface to create the water-tight seal.

In an embodiment, a template, stencil, etc., may be used to place the fasteners on the surface such that the fasteners, once installed, are aligned with the through holes in the solar panel module, respectively. For example, a template may be disposed on the surface (e.g., laid down), indicating locations at which to secure the fasteners into the surface. Any number of the fasteners may be secured into the surface, using the template, for example, and once the fasteners are installed, the template may be removed. In an embodiment, however, the template may remain on the surface. Regardless, by using the template, the fasteners may be aligned with the through holes on the solar panel module once installed. The template may be based at least in part on the solar panel module to accommodate the through holes of the solar panel module.

As another example, the solar panel module may be disposed on the surface and the surface may be marked at locations corresponding to the through holes. Therein, the fasteners may be disposed into the surface at locations corresponding to the through holes. Other tools, instruments, etc., may be used to secure the fasteners into the surface to ensure that the fasteners are aligned with the through holes of the solar panel module.

In an embodiment, the spacer may be secured to the solar panel module before installation on the surface. For example, the spacer may be aligned with the through holes and secured to the solar panel module using any suitable manner. For example, the spacer may be adhered to the solar panel module, threaded into the solar panel module, press-fit to the solar panel module, fastened to the solar panel module, etc., adjacent to the through holes. In an embodiment, securing the spacers to the solar panel module before installation may reduce an installation time, and/or an amount of time that installers are working on the surface. For example, the spacers may be installed on a ground, or off the surface, prior to transporting the solar panel modules to the surface for installation.

Securing the spacers to the solar panel module before the installation may also avoid issues of aligning the fasteners with the through holes. In instances where the spacers are pre-installed on the solar panel module, the spacers may be aligned with the through holes, and when the solar panel module is disposed on the surface, a fastener may be disposed or otherwise positioned through the through hole, the channel of the spacer, and into the surface. In an embodiment, when the fasteners are removed to service the solar panel module, the spacers may remain secured to the surface or the solar panel module. In such instances, the spacers may be removable from the solar panel module.

In an embodiment, the attachment mechanism or the solar panel module may be used in conjunction with one or more rails. For example, in an embodiment, the attachment mechanism may be used to secure a rail to the surface. The spacer, for example, may be disposed between the rail and the surface, whereby the fastener secures the rail to the surface. In such instances, the attachment mechanisms may be located internally and/or externally to the solar cells of the solar panel module. One or more mounts, brackets, clamps, etc., may be used to secure the solar panel modules to the rail. The rail may also be secured to the surface using one or more of the attachment mechanisms.

Additionally, or alternatively, the attachment mechanism may be used in conjunction with other connectors, couplers, anchors, mounts, etc., that are used to secure the solar panel module or a frame of the solar panel module to the surface. For example, the connector may be secured to the solar panel module and the attachment mechanism may be used to secure the connector to the surface. The connector may be used in conjunction with solar panel modules that include or omit the through holes. Still, in an embodiment, a frame may be secured to the solar panel module, whereby the frame may include through holes. The fasteners of the attachment mechanism may be disposed through the frame to secure the solar panel module to the surface.

The attachment mechanism may also be used in conjunction with other rail-based or rail-less-based systems to secure the solar panel modules to the surface. For example, a series of rails may be disposed along the surface, and the solar panel modules may be secured to the rails via brackets, mounts, etc. In an embodiment, the brackets, mounts, etc., may secure to the solar panel modules along an edge, perimeter, etc., of the solar panel module. The attachment mechanisms, as described herein, may be used in combination with such rail-based systems, for example, to support the solar panel module at a location internal to the edge, perimeter, etc.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting embodiments. The features illustrated or described in connection with one embodiment may be combined with the features of other embodiments. Such modifications and variations are intended to be included within the scope of the appended claims.

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

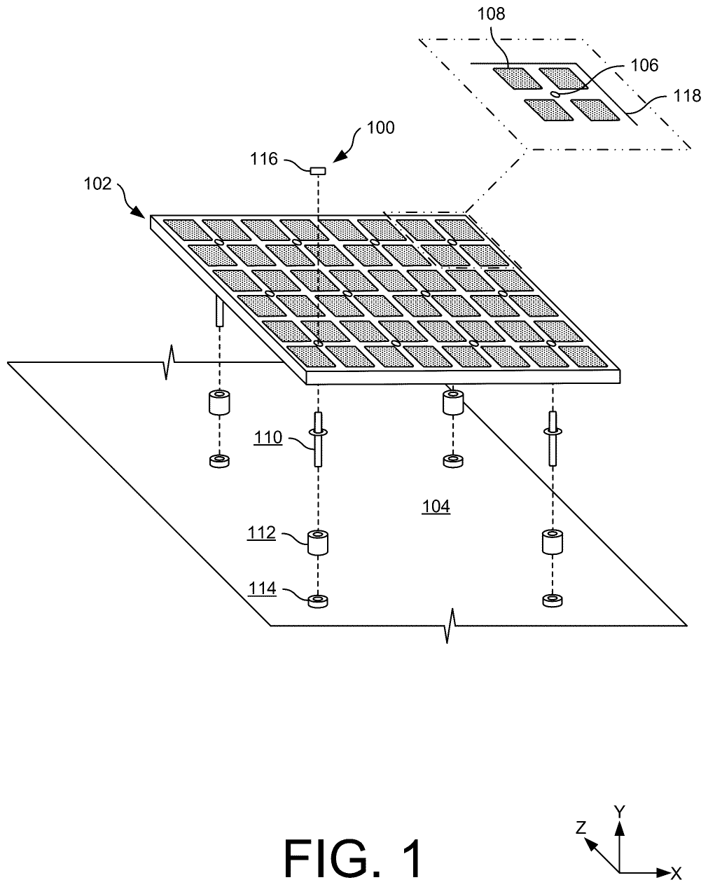

FIG. 1 illustrates an example attachment mechanism 100 to secure a solar panel module 102 to a surface 104, according to an embodiment of the present disclosure. The view shown in FIG. 1 illustrates an exploded view of the attachment mechanism 100 and illustrates the solar panel module 102 being disposed above the surface 104. In an embodiment, the surface 104 may represent any suitable surface, such as a roof (e.g., composite shingle roof, metal roof, tile roof, etc.), deck, and so forth. However, as will be explained herein, the attachment mechanism 100 is utilized to secure the solar panel module 102 to the surface 104.

The solar panel module 102 may include a plurality of through holes 106. For example, the through holes 106 may be disposed through the solar panel module 102 (e.g., between a bottom surface and a top surface of the solar panel module 102). In an embodiment, the through holes 106 may be disposed through the solar panel module 102, at locations inside a perimeter 118 (e.g., periphery, edge, border, etc.) of the solar panel module 102. In an embodiment, the through holes 106 may be disposed through the solar panel module 102 at locations internal to, in between, adjacent to, etc., solar cells 108 of the solar panel module 102. Alternatively, the through holes 106 may be disposed internal to or external to a perimeter that extends around the solar cells 108. The solar cells 108 may be arranged in any pattern, group, etc., about the solar panel module 102.

The through holes 106 may be formed through glass, encapsulants, layers, etc., of the solar panel module 102. In an embodiment, the through holes 106 may be formed during manufacturing, or after manufacturing (e.g., via an installer). The through holes 106 themselves may be any shape, size, configuration, etc. As will be explained herein, the through holes 106 may correspond to attachment locations, mounting locations, etc., by which the solar panel module 102 is secured to the surface 104. However, not all of the through holes 106 may be used in conjunction with securing the solar panel module 102 to the surface 104.

In an embodiment, the attachment mechanism 100 may include a fastener 110, a spacer 112, a seal 114, and/or nut 116. The fastener 110 may be disposable or positionable through the spacer 112, the seal 114, and into the surface 104. For example, the fastener 110 may be threaded into the surface 104. An end of the fastener 110, opposite an end of the fastener 110 that is secured into the surface 104, may be disposed through one of the through holes 106. For example, an end of the fastener 110 may protrude through the solar panel module 102 via the through hole 106. The nut 116 may be threaded onto the fastener 110 to secure the solar panel module 102 to the surface 104. The nut 116 may be a hex nut, wing nut, flange nut, etc. In this manner, the solar panel module 102 may be disposed between the spacer 112 and the nut 116.

A plurality of the attachment mechanisms 100 may be used to secure the solar panel module 102 to the surface 104. For example, although FIG. 1 illustrates four of the attachment mechanisms 100 being used to secure the solar panel module 102 to the surface 104, more than or less than four of the attachment mechanisms 100 may be used. In such instances, additional fasteners may be secured into the surface 104 and the additional fasteners may be disposed through additional through holes 106 to secure the solar panel module 102 to the surface 104. In addition, the attachment mechanism 100 may be used in conjunction with other mounts, brackets, etc., that secure the solar panel module 102 to the surface 104.

Although the spacer 112 and the seal 114 are described as being separate components, in an embodiment, the spacer 112 may act as a seal to prevent an ingress of liquid into a penetration created by the fastener 110. For example, a material of the spacer 112 may act as a seal around the penetration. Additionally, or alternatively, caulk, epoxy, etc., may be disposed between the spacer 112 (or the seal 114, when used) and the surface 104 to prevent an ingress of liquid. As yet another example, the spacer 112 may include a counterbore that is filled with a sealant to seal around the penetration and/or draw the sealant into the penetration via an engagement with the fastener 110. Further, although the fastener 110 is described as directly securing into the surface 104, the fastener 110 may be secured into other flashings, mounts, brackets, etc., disposed in the surface 104.

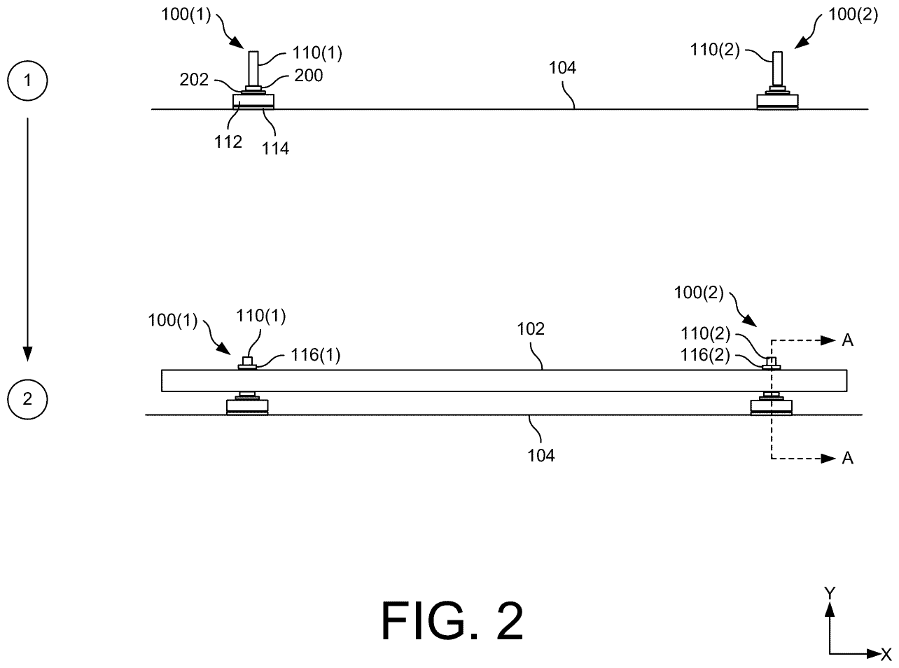

FIG. 2 illustrates an example sequence to secure the solar panel module 102 to the surface 104 using the attachment mechanisms 100, such as an attachment mechanism 100(1) and an attachment mechanism 100(2), according to an embodiment of the present disclosure. At “1” in FIG. 2, the fasteners 110 may be at least partially disposed through the spacers 112, the seals 114, and into the surface 104. In an embodiment, a nut 200 may be threaded onto the fastener 110 and used to drive the fastener 110 into the surface 104. For example, the fastener 110 may represent a hanger bolt. The nut 200 may be driven to compress the spacer 112 and the seal 114 against the surface 104. In an embodiment, a washer 202 may be disposed between the nut 200 and the spacer 112 to spread a force against the spacer 112 generated as the nut 200 is driven into the surface 104. As shown at “1” in FIG. 2, a fastener 110(1) of the attachment mechanism 100(1) and a fastener 110(2) of the attachment mechanism 100(2) may be secured to the surface 104. However, more than two of the attachment mechanisms 100 may be secured into the surface 104.

At “2” in FIG. 2, the solar panel module 102 may be disposed onto or over the fastener 110. For example, a first through hole (e.g., one of the through holes 106) of the solar panel module 102 may be disposed over an end of the fastener 110(1) and a second through hole (e.g., another of the through holes 106) of the solar panel module 102 may be disposed over an end of the fastener 110(2). To secure the solar panel module 102 to the surface 104, a nut 116(1) may be threaded onto the fastener 110(1) and a nut 116(2) may be threaded onto the fastener 110(2).

The spacer 112 serves to space, offset, dispose, etc., the solar panel module 102 above the surface 104 to permit water shedding. In an embodiment, a height of the spacer 112 (e.g., in the Y-direction) may be variable to adjust a gap distance between the solar panel module 102 and the surface 104. As shown, when the solar panel module 102 is secured to the surface 104 (e.g., at “2” in FIG. 2), the solar panel module 102 may be disposed between the nut 116 and the nut 200 of the attachment mechanism 100. However, in an embodiment, the solar panel module 102 may rest on or be disposed against other mediums, substrates, layers, etc., to prevent damage.

The fasteners 110 may be secured into the surface 104 so as to align with or accommodate the through holes 106. In an embodiment, a template, stencil, etc., may be on the surface 104 and locations of the through holes 106 may be scribed or otherwise marked on the surface 104. The template may be used such that the fasteners 110, once installed, are aligned with the through holes 106 in the solar panel module 102, respectively. Any number of the fasteners 110 may be secured into the surface 104 using the template. For example, the fastener 110(1) may be aligned with a location on the template associated with a location corresponding to a first of the through holes 106, and the fastener 110(2) may be aligned with a location on the template associated with a location corresponding to a second of the through holes 106. Other tools, instruments, mechanisms, etc., may be used to mark the locations of the through holes 106 on the surface 104.

In an embodiment, the attachment mechanism 100 may include more than one fastener. For example, a first fastener may be used to secure the spacer 112 to the surface 104 and a second fastener may be used to secure the solar panel module 102 to the spacer 112. As shown, the attachment mechanism 100 may be spaced inward from the perimeter 118 of the solar panel module 102 (e.g., in the X- and/or Z-direction). In this manner, the attachment mechanism 100 may be secured to the solar panel module 102 at a location within the perimeter 118, or stated alternatively, the solar panel module 102 may be secured to the surface 104 at a location inward, internal to, etc., the perimeter 118.

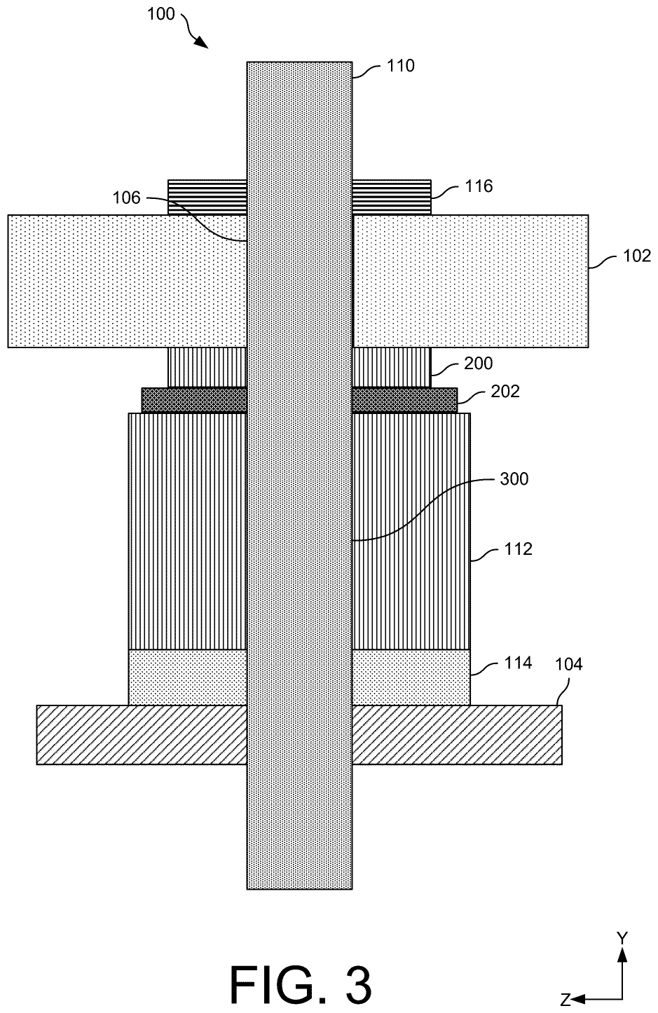

FIG. 3 illustrates a cross-sectional view of the attachment mechanism 100 and the solar panel module 102, taken along line A-A of FIG. 2, according to an embodiment of the present disclosure. The fastener 110 extends through a channel 300 of the spacer 112. The fastener 110 also extends through the seal 114 and the washer 202, both of which may have an associated channel through which the fastener 110 is disposed. The fastener 110, as noted above, may be secured into the surface 104 through the use of the nut 200 threaded onto the fastener 110. The nut 200 may be driven (e.g., via a socket) to drive the fastener 110 into the surface 104. That is, as discussed above in FIG. 2, prior to the solar panel module 102 being disposed onto/over the fastener 110, the fastener 110 may be driven into the surface 104. Tightening the nut 200 compresses the spacer 112 and the seal 114 against the surface 104 to create a watertight seal around the penetration in the surface 104 caused by the fastener 110. Although not shown, sealant (e.g., butyl, epoxy, etc.) may be disposed between the seal 114 and the surface 104 to provide a further seal.

Once the fastener 110 is secured into the surface 104, the fastener 110 may be disposed through the through hole 106 in the solar panel module 102. For example, the solar panel module 102 may be lifted onto and over the fastener 110 by aligning the through hole 106 with the fastener 110. During this, any number of the through holes 106 may be aligned with respective fasteners 110 secured into the surface 104. The nut 116 may be threaded onto the fastener 110 to secure the solar panel module 102 to the surface 104. In an embodiment, pads, washers, etc., may be disposed between the nut 116 and/or the nut 200 to avoid any damage to the solar panel module 102.

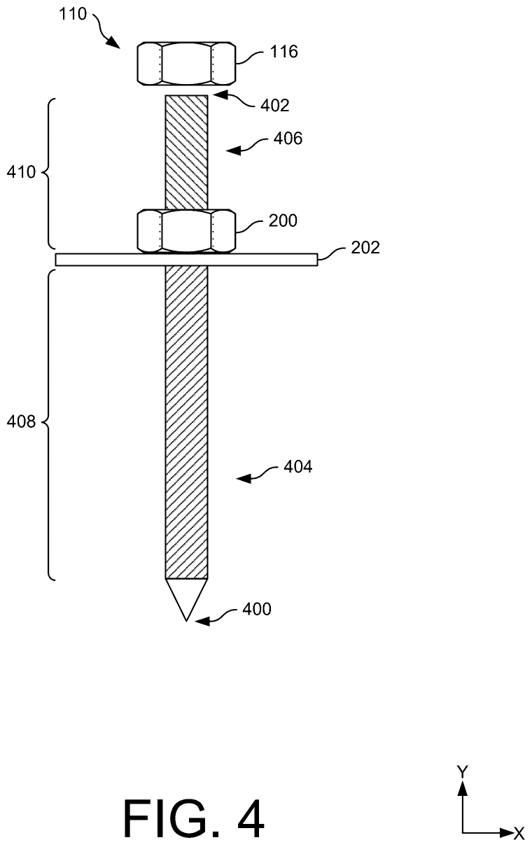

FIG. 4 illustrates the fastener 110 of the attachment mechanism 100, according to an embodiment of the present disclosure. In an embodiment, the fastener 110 may resemble a hanger bolt (e.g., a headless hanger bolt).

The fastener 110 includes a first end 400 and a second end 402 spaced apart from the first end 400 (e.g., in the Y-direction). A length of the fastener 110 extends between the first end 400 and the second end 402. The first end 400 may be threaded into the surface 104, while the nut 116 may be threaded onto the second end 402.

The fastener 110 may include first threads 404 disposed along a first length 408 of the fastener 110 and second threads 406 disposed along a second length 410 of the fastener 110. In an embodiment, the first threads 404 may include coarse or wood threads for threading the fastener 110 into the surface 104. The second threads 406 may include fine or machined threads to receive the nut 116. In an embodiment, the first length 408 may be greater in length than the second length 410.

In an embodiment, the nut 200 may be threaded onto the second threads 406. The nut 200 may be advanced to an end of the second threads 406. Once the nut 200 is fully advanced on the second threads 406 (e.g., in the Y-direction), the nut 200 may be driven to transfer rotational movement to the fastener 110 for driving the first end 400 into the surface 104. Alternatively, in an embodiment, a portion of the fastener 110, between the first threads 404 and the second threads 406, may not include any threads. For example, a portion of the length of the fastener 110 between the first threads 404 and the second threads 406 may not include threads. In this instance, the nut 200 may bottom out on the second threads 406 and not advance onto the unthreaded portion. Therein, motion may be imparted to the fastener 110 for advancing the fastener 110 into the surface 104

The fastener 110 may be driven by any degree to compress the spacer 112 and/or the seal 114 against the surface 104. In an embodiment, the washer 202 may be omitted and the nut 200 may include a flanged nut. With the fastener 110 secured into the surface 104, the nut 116 may be threaded onto the second end 402 to secure the solar panel module 102 between the nut 116 and the nut 200 (once the solar panel module 102 is positioned on the fastener 110).

In an embodiment, the first threads 404 may be right-handed threads and the second threads 406 may be left-handed threads, vice versa. The different-handed threads may avoid unthreading the fastener 110 from the surface 104 when the nut 116 is removed, for example, to service the solar panel module 102. In an embodiment, the fastener 110 may include a constant diameter or different diameters. For example, the first length 408 may include a first diameter and the second length 410 may include a second diameter different than the first diameter.

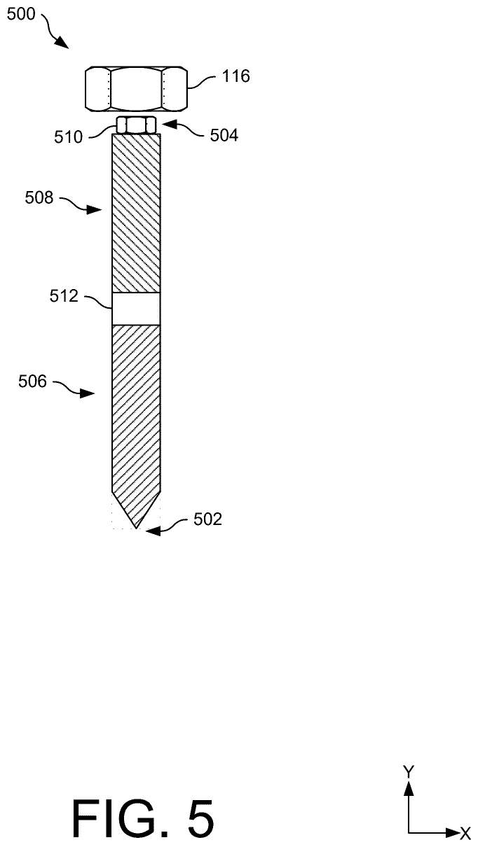

FIG. 5 illustrates a fastener 500 that may be usable with the attachment mechanism 100, according to an embodiment of the present disclosure. For example, the fastener 500 may be used to secure the spacer 112 to the surface 104 and may be used in lieu of the fastener 110. In an embodiment, the fastener 500 may resemble a hanger bolt (e.g., headed hanger bolt).

The fastener 500 includes a first end 502 and a second end 504 opposite the first end 502 (e.g., in the Y-direction). The fastener 500 may include first threads 506 and second threads 508, which may be similar to the first threads 404 and the second threads 406, respectively, of the fastener 110. However, as shown, the fastener 500 may include a head 510 that is used to drive the fastener 500 into the surface 104. The head 510 is shown being disposed at the first end 502. For example, rather than the nut 200 being used to drive a fastener into the surface 104, the head 510 may receive a socket for driving the fastener 500 into the surface 104. Although shown as a hex-head, the fastener 110 may include a hex-socket located at the second end 504, a Phillips or standard head located at the second end 504, etc. Moreover, the nut 116 may be threaded onto the fastener 500 after securing the fastener 500 into the surface 104, or before securing the fastener 500 into the surface 104.

The first threads 506 and the second threads 508 are shown being separated by a shank 512, where the shank 512 does not include any threads. The nut 116 may bottom out on the second threads 508 and not advance onto the shank 512.

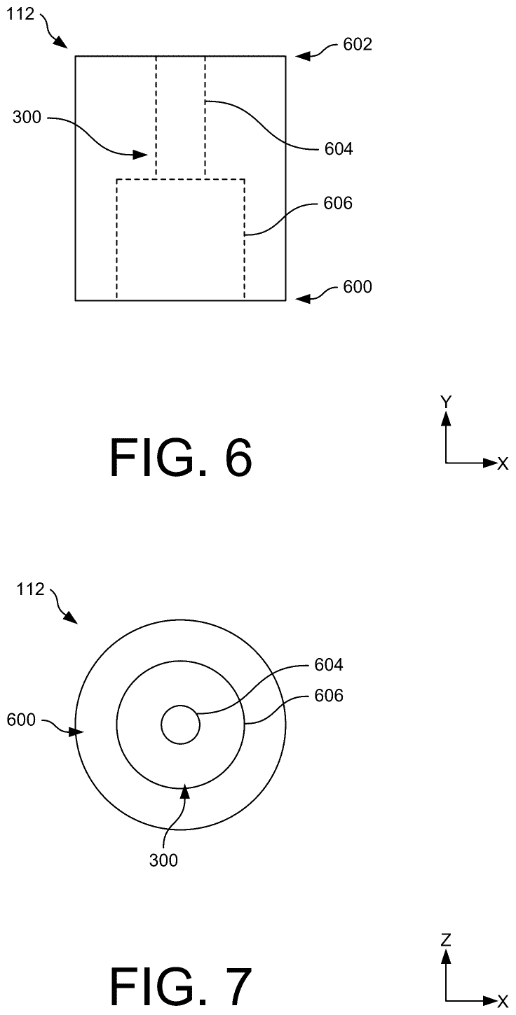

FIG. 6 illustrates the spacer 112 of the attachment mechanism 100, according to an embodiment of the present disclosure. The spacer 112 includes a first end 600 and a second end 602 spaced apart from the first end 600 (e.g., in the Y-direction). When secured to the surface 104, the first end 600 may be disposed adjacent to the surface 104 (or the seal 114), and the second end 602 may be disposed adjacent to the nut 200 and/or the washer 202. The spacer 112 may be manufactured from rubber, neoprene, plastic, etc.

The channel 300 may be disposed through the spacer 112, between the first end 600 and the second end 602. In an embodiment, the channel 300 may include a first portion 604 having a first size, cross-sectional dimension, etc., and a second portion 606 having a second size, cross-sectional dimension, etc. In an embodiment, the diameter of the first portion 604 may be sized smaller than the diameter of the fastener 110 and/or the fastener 500 such that an interference fit is formed. This may prevent an ingress of liquid through the channel 300 and into the surface 104.

In an embodiment, the second portion 606 may represent a counterbore of the spacer 112. A sealant (e.g., caulk, epoxy, butyl, etc.) may be disposed within the second portion 606 to seal the spacer 112 against the surface 104. The sealant may be applied within the second portion 606 prior to securing the spacer 112 to the surface 104. The sealant may be a flowable sealant, an injectable sealant, an adhesive sealant, etc. As the fastener 110 is advanced into the surface 104, the sealant may become entwined, entangled, etc., with the threads of the fastener 110 and drawn into the surface 104 to seal penetrations in the surface 104.

FIG. 7 illustrates an end view of the spacer 112, according to an embodiment of the present disclosure. In an embodiment, the spacer 112 may be circular in shape, however, other shapes are envisioned (e.g., square, hexagonal, etc.). Moreover, as shown, the channel 300 may be circular in shape, although other shapes are envisioned. As introduced above, sealant may be disposed within the second portion 606 to seal the spacer 112 against the surface 104. Although described as including the second portion 606, in an embodiment, the second portion 606 may be omitted and/or the channel 300 may have a consistent cross-section dimension. In such instances, the channel 300 may or may not be at least partially filled with the sealant.

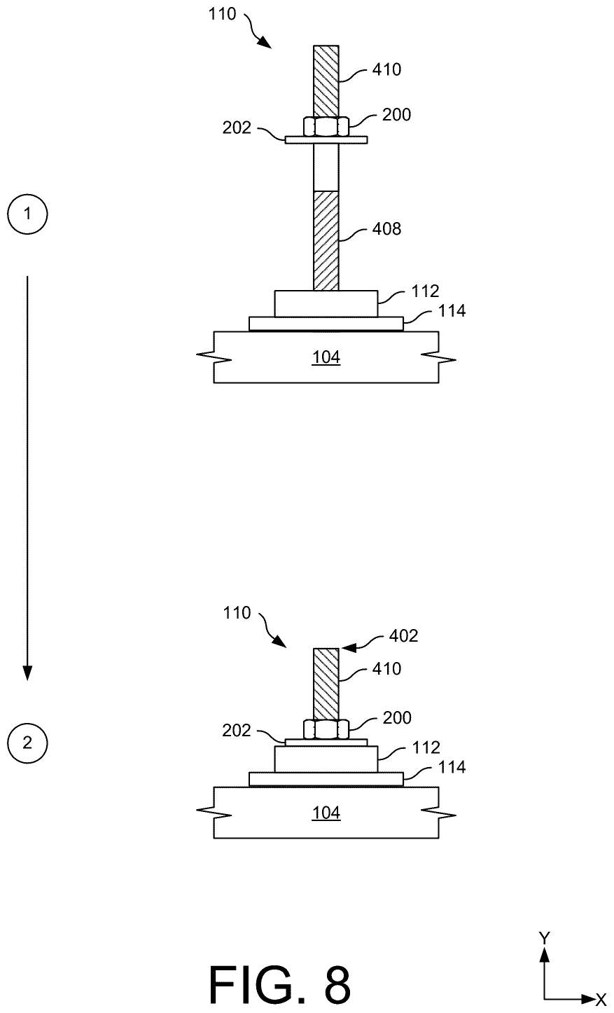

FIG. 8 illustrates an example sequence to secure the fastener 110 to the surface 104, according to an embodiment of the present disclosure. As illustrated at “1” in FIG. 8, the fastener 110 may be at least partially disposed through the spacer 112 (e.g., via the channel 300) and the seal 114. In addition, the fastener 110 may be at least partially disposed into the surface 104. As discussed above, the location of the fastener 110 on the surface 104 may be based on the location of the through holes 106 in the solar panel module 102 (e.g., using a template). The nut 200 may be driven on the second threads 406, and thereafter, a socket may be used to drive the fastener 110 into the surface 104 (e.g., based on the nut 200 bottoming out on the second threads 406).

At “2” in FIG. 8, the fastener 110 is secured to the surface 104. For example, the fastener 110 may be driven into the surface 104 via the socket. The washer 202 may spread a load to the spacer 112 to seal the seal 114, for example, between the spacer 112 and the surface 104. This prevents an ingress of liquid into the surface. In addition, sealant disposed within the channel 300 (or the second portion 606) may assist in sealing the penetration.

After being secured to the surface 104, a portion of the fastener 110 (e.g., the second end 402) may represent a post, pillar, etc., that accommodates or receives the through hole 106 of the solar panel module 102. For example, the second end 402 may be disposed through the through hole 106, and thus, the fastener 110 may be used to secure the solar panel module 102 to the surface 104.

The scenario illustrated in FIG. 8 may be repeated for other fasteners. For example, across the surface 104, a plurality of the fasteners 110 may be secured to the surface 104 to mount the solar panel module 102 to the surface 104. In addition, although not shown, a spacer, bushing, etc., may be disposed adjacent to the nut 200 such that an underneath side of the solar panel module 102 may rest on the spacer.

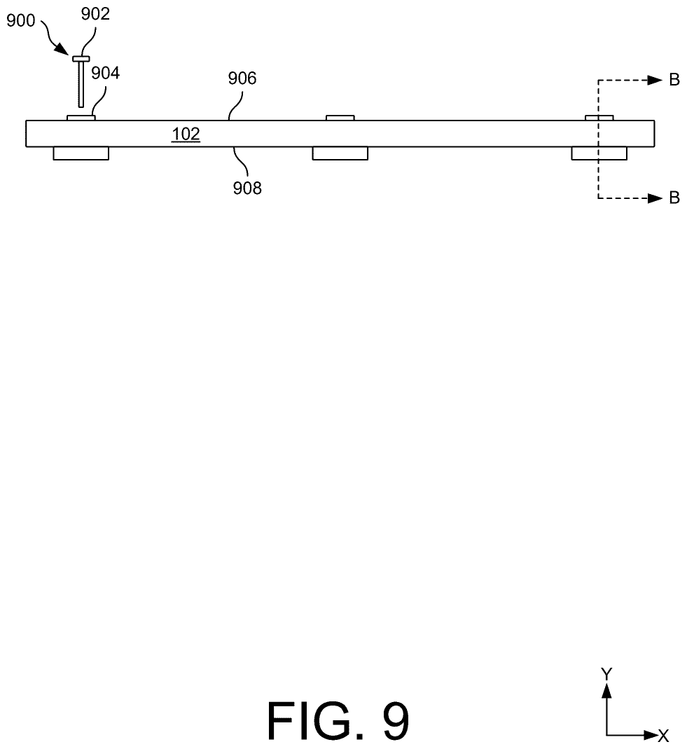

FIG. 9 illustrates an attachment mechanism 900 that may be used to secure the solar panel module 102 to the surface 104, according to an embodiment of the present disclosure. The attachment mechanism 900 may be similar to the attachment mechanism 100 as discussed above. For example, the attachment mechanism 900 may include a fastener 902 and a spacer 904. However, compared to the spacer 112 of the attachment mechanism 100, the spacer 904 of the attachment mechanism 900 may be secured to the solar panel module 102, or a frame thereof. For example, as will be explained herein, the spacer 904 may be at least partially disposed through the through hole 106 of the solar panel module 102 to secure the spacer 904 to the solar panel module 102. Therein, the fastener 902 may be disposed through the spacer 904 and the solar panel module 102, into the surface 104.

In an embodiment, a portion of the spacer 904 may be disposed adjacent to a top surface 906 of the solar panel module 102 and a portion of the spacer 904 may be disposed adjacent to a bottom surface 908 of the solar panel module 102. The spacer 904 may be at least partially secured with the through hole 106 of the solar panel module 102. As also shown in FIG. 9, more than one of the spacers 904 may be secured to the solar panel module 102. In an embodiment, the fasteners 902 may be disposed through respective spacers 904 and into the surface 104, or alternatively, the spacers 904 may act as standoffs to support the solar panel module 102 above the surface 104. In such instances, the fasteners 902 may not be used to secure spacers 904 to the surface 104.

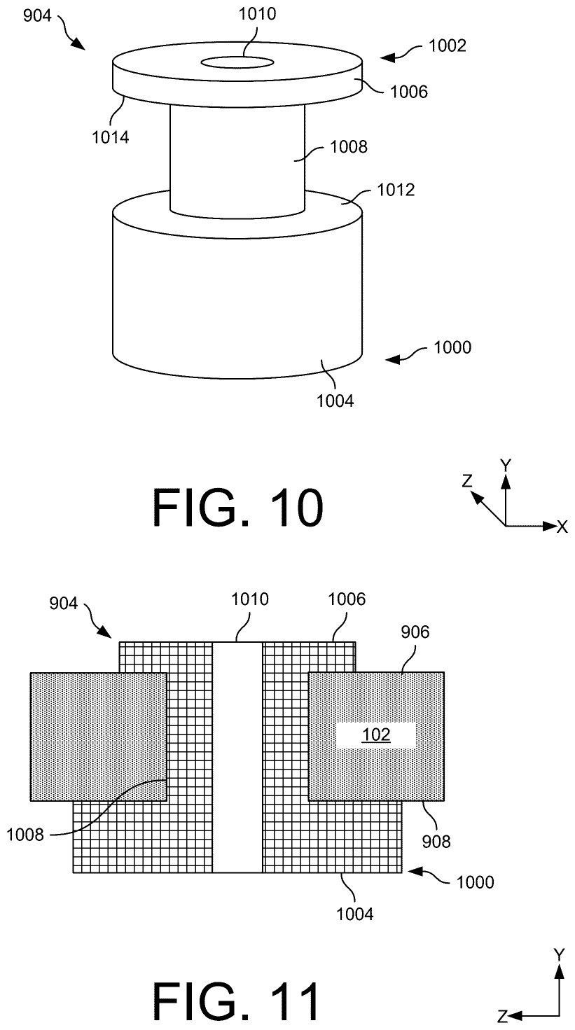

FIG. 10 illustrates an isometric view of the spacer 904 of the attachment mechanism 900, according to an embodiment of the present disclosure. The spacer 904 includes a first end 1000 and a second end 1002 spaced apart from the first end 1000 (e.g., in the Y-direction). The first end 1000 may be disposed beneath the bottom surface 908 and the second end 1002 may be disposed above the top surface 906. In an embodiment, the first end 1000 may be disposed against the surface 104 and/or the seal 114.

The spacer 904 may include a base 1004 (e.g., first portion, segment, etc.) disposed at the first end 1000 and a flange 1006 (e.g., second portion, segment, etc.) disposed at the second end 1002. Moreover, the spacer 904 may include a neck 1008 disposed between the base 1004 and the flange 1006. In an embodiment, the neck 1008 may be disposed through the through hole 106 of the solar panel module 102. A length of the neck 1008 (e.g., in the Y-direction) accommodates a depth of the through hole 106. In an embodiment, when disposed through the through hole 106, a surface 1012 of the base 1004 may engage with the bottom surface 908 and a surface 1014 of the flange 1006 may engage the top surface 906.

The base 1004 may include a first cross-sectional dimension that is either the same as, or different than, a second cross-sectional dimension as the flange 1006. The neck 1008, however, may include a third cross-sectional dimension that is smaller than the first cross-sectional dimension and/or the second cross-sectional dimension. The third cross-sectional dimension accommodates a diameter of the through hole 106. The first cross-sectional dimension of the base 1004 and/or the second cross-sectional dimension of the flange 1006 may be greater than the diameter of the through hole 106.

The spacer 904 may be pre-installed on the solar panel module 102, for example, before the solar panel module 102 is transported to the surface 104. In an embodiment, the second end 1002 of the spacer 904 may be pushed, advanced, etc., through the through hole 106. During this, the flange 1006 may be temporarily deformed to advance the flange 1006 through the through hole 106. The spacer 904 may therefore be pliable and/or deformable (e.g., rubber, silicone, etc.). However, once pushed through the through hole 106, the flange 1006 may expand outwards to be disposed adjacent to the top surface 906.

The spacer 904 may also include a channel 1010 to accommodate the fastener 902. The channel 1010 may be disposed through the spacer 904, and the channel 1010 may include a counterbore for receiving caulk, sealant, etc. The channel 1010 may include a constant diameter or different diameters. For example, a second portion of the channel 1010 may be sized larger or include a greater cross-sectional dimension than a first portion of the channel 1010 to receive the sealant (e.g., similar to the channel 300).

FIG. 11 illustrates a cross-sectional view of the solar panel module 102 and the spacer 904, taken along line B-B of FIG. 9, according to an embodiment of the present disclosure. When installed on the solar panel module 102, the base 1004 may be disposed adjacent to the bottom surface 908 and the flange 1006 may be disposed adjacent to the top surface 906. The positioning of the base 1004 adjacent to the bottom surface 908 and the flange 1006 adjacent to the top surface 906 may secure the spacer 904 to the solar panel module 102 (e.g., to pre-install the spacer 904 on the solar panel module 102). In other words, the solar panel module 102 may be sandwiched or disposed between the base 1004 and the flange 1006. The neck 1008 may extend through a thickness (e.g., in the Y-direction) of the solar panel module 102. As discussed above, the fastener 902 may be disposed through the channel 1010 and into the surface 104 to secure the solar panel module 102 to the surface 104.

Although not shown, the channel 1010 may include a counterbore, cavity, etc., at the first end 1000 to receive the sealant. Additionally, or alternatively, the seal 114 (or other gasket, washer, etc.) may be disposed adjacent to the first end 1000 and disposed against the surface 104. The fastener disposed through the channel 1010 may be used in conjunction with a washer that is disposed adjacent to the flange 1006.

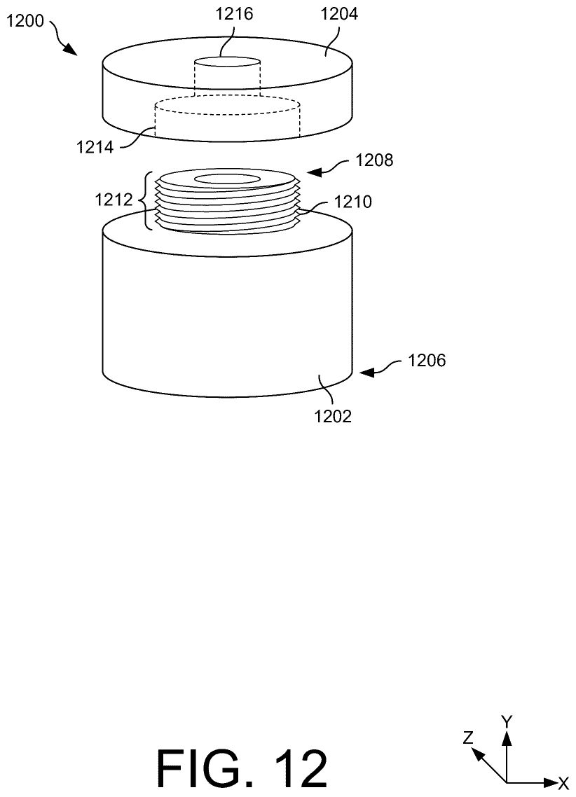

FIG. 12 illustrates a spacer 1200, according to an embodiment of the present disclosure. In an embodiment, the spacer 1200 may be used instead of the spacer 904. The spacer 1200 may include a base 1202 and a cap 1204 that secures to the base 1202. The base 1202 may include a first end 1206 and a second end 1208 spaced apart from the first end 1206 (e.g., in the Y-direction). The base 1202 may include threads 1210 disposed on a neck 1212 of the base 1202. The neck 1212 may be disposed at or extend from the second end 1208. In an embodiment, the second end 1208 may be disposed through the through hole 106 of the solar panel module 102. The neck 1212 may therefore be sized to be disposed within the through hole 106 of the solar panel module 102.

The cap 1204 may be threaded onto the threads 1210. For example, the threads 1210 may be disposed adjacent to the top surface 906 of the solar panel module 102 and the cap 1204 may be threaded onto the threads 1210. Alternatively, the cap 1204 may engage with the threads 1210 inside the through hole 106. The cap 1204 may include a receptacle 1214 having corresponding threads that engage with the threads 1210 to secure the spacer 1200 to the solar panel module 102. The spacer 1200 may include a channel 1216 disposed through the base 1202 and the cap 1204 to receive a fastener that connects the solar panel module 102 to the surface 104. The cap 1204 may define a first portion of the channel 1216 and the base 1202 may define a second portion of the channel 1216. The first portion of the channel 1216 may be adjoined to the receptacle 1214. The channel 1216 may also include a counterbore, for example, proximate to the first end 1206 of the base 1202 that receives sealant.

In an embodiment, the spacer 1200 may be pre-installed on the solar panel module 102. Moreover, during servicing of the solar panel module 102, the fastener may be removed and the cap 1204 may be unthreaded from the base 1202. In this instance, the solar panel module 102 may be removed without removing the base 1202 from the surface 104. For example, the base 1202 may be secured to the surface 104 via the sealant. As such, using the spacer 1200, the solar panel module 102 may be removed from the surface 104, while keeping the base 1202 secured to the surface 104, thereby avoiding compromising the integrity of a seal of the base 1004 against the surface 104.

As another example, the base 1202 may be secured to the surface 104 using a fastener, and the solar panel module 102 may secure to the surface 104 when the cap 1204 is threaded onto the base 1202. The fastener may therefore not be removed during servicing, but unscrewing the cap 1204 from the base 1202 permits the solar panel module 102 to be removed.

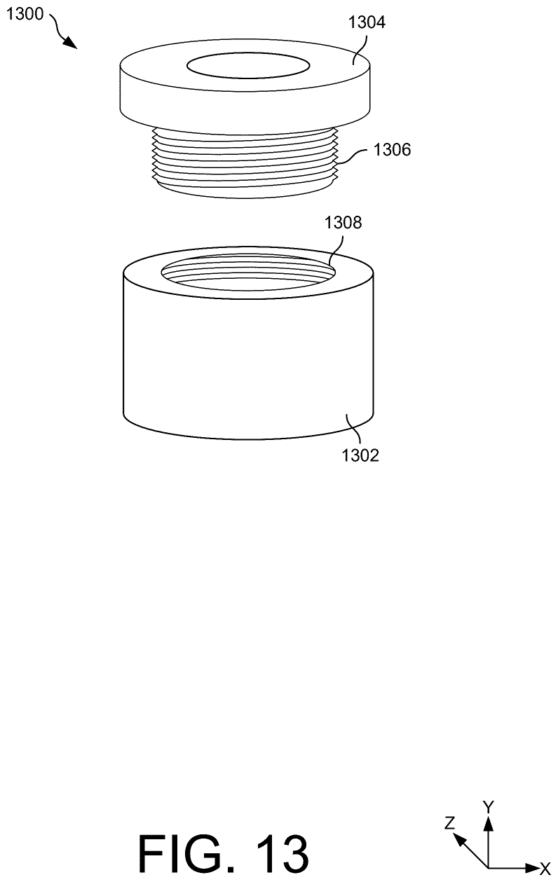

FIG. 13 illustrates a spacer 1300 that may be implemented with the attachment mechanism 900, according to an embodiment of the present disclosure. In an embodiment, the spacer 1300 may be used instead of the spacer 904 and/or the spacer 1200. The spacer 1300 may be similar to the spacer 1200. For example, the spacer 1300 may include a base 1302 and a cap 1304. However, compared to the spacer 1200, the cap 1304 may include threads 1306 that are threaded into a receptacle 1308 of the base 1302 to secure the spacer 1300 to the solar panel module 102.

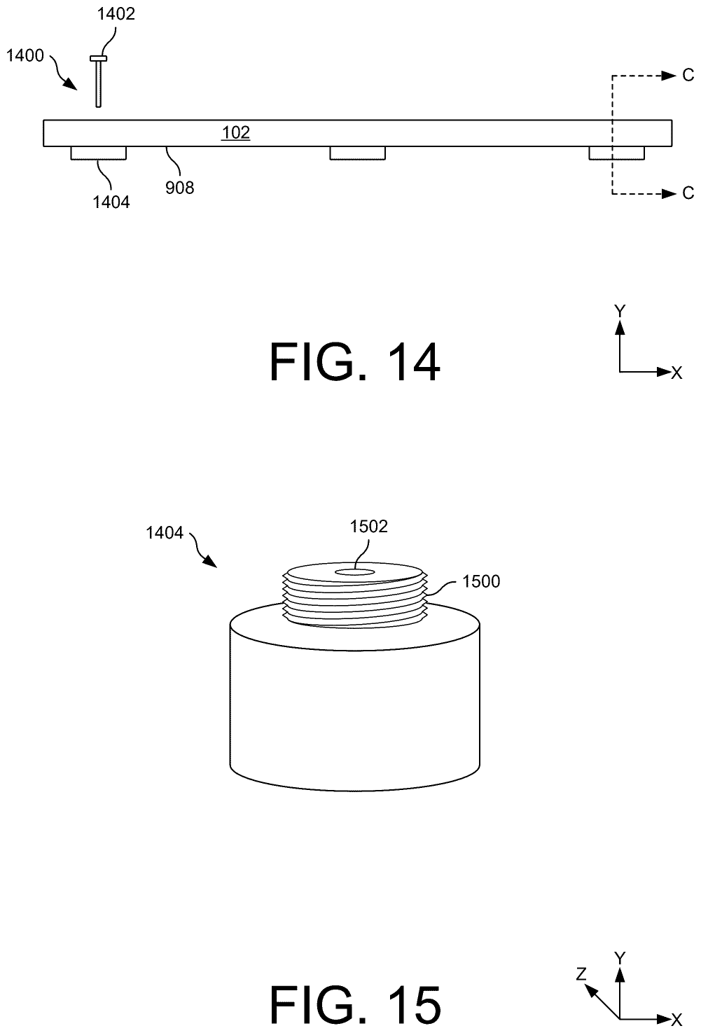

FIG. 14 illustrates an attachment mechanism 1400 that may be used to secure the solar panel module 102 to the surface 104, according to an embodiment of the present disclosure. The attachment mechanism 1400 may be similar to the attachment mechanism 100 and/or the attachment mechanism 900 as discussed above. For example, the attachment mechanism 1400 may include a fastener 1402 and a spacer 1404. However, the spacer 1404 of the attachment mechanism 1400 may secure to the solar panel module 102, or a frame thereof. For example, the spacer 1404 may be secured to the bottom surface 908 of the solar panel module 102 and/or within the through hole 106 of the solar panel module 102. In an embodiment, the spacer 1404 may be threaded into the through hole 106, press-fit into the through hole 106, and/or snapped into the through hole 106.

FIG. 15 illustrates the spacer 1404 of the attachment mechanism 1400, according to an embodiment of the present disclosure. As shown, the spacer 1404 may include threads 1500 that may be threaded into the through hole 106 of the solar panel module 102 to connect the spacer 1404 to the solar panel module 102. In other embodiments, the threads 1500 may be omitted and the spacer 1404 may include a neck that is disposed at least partially through the through hole 106. The spacer 1404 may include a channel 1502 such that the fastener 1402 may be disposed through the through hole 106, the channel 1502, and into the surface 104. The spacer 1404 may also be used in conjunction with the seal 114, and/or the channel 1502 may include a counterbore to receive the sealant.

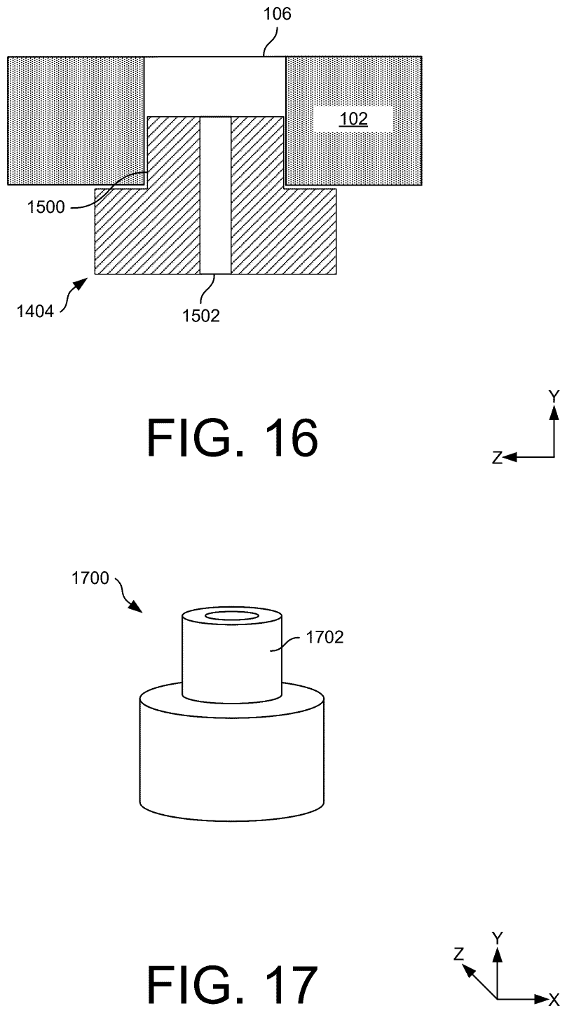

FIG. 16 illustrates a cross-sectional view of the spacer 1404 and the solar panel module 102, taken along line C-C of FIG. 14, according to an embodiment of the present disclosure. The spacer 1404 may be threaded into the through hole 106, for example, to connect the spacer 1404 to the solar panel module 102. The through hole 106 may be threaded with corresponding threads to receive the threads 1500 of the spacer 1404. In an embodiment, the spacer 1404 may be at least partially threaded through the through hole 106.

FIG. 17 illustrates an example spacer 1700 that may be used with the attachment mechanism 1400, according to an embodiment of the present disclosure. In an embodiment, the spacer 1700 may be used instead of the spacer 1404. The spacer 1700 may include a neck 1702 that is disposed within the through hole 106 of the solar panel module 102. In an embodiment, the neck 1702 may be pressed into the through hole 106 as compared to being threaded into the through hole 106. In an embodiment, the spacer 1700 may remain secured to the surface 104 (e.g., with the use of butyl) during removal of the solar panel module 102 and/or may be removed with the solar panel module 102.

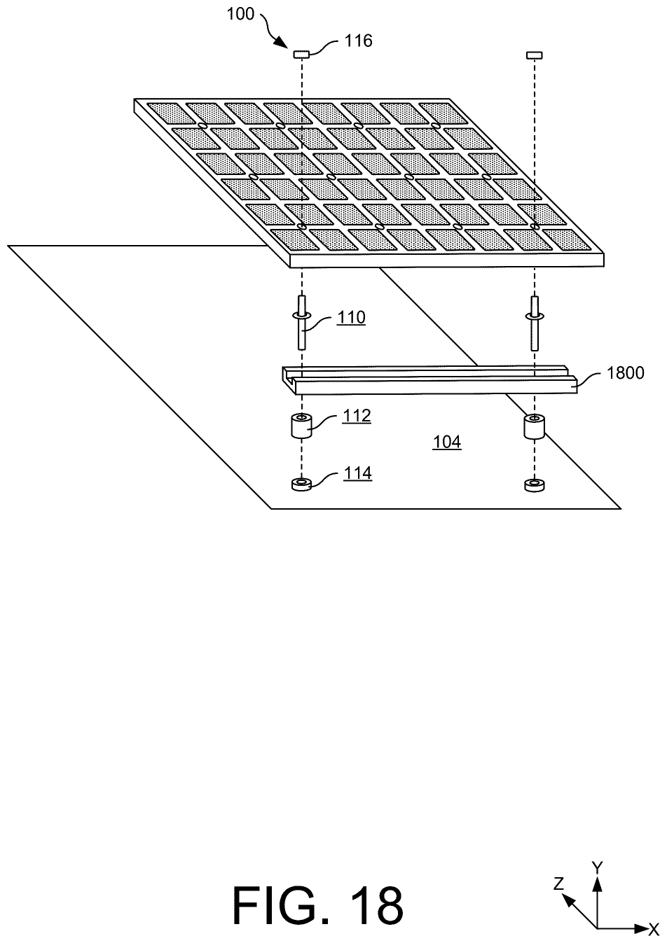

FIG. 18 illustrates the attachment mechanism 100 being used with a rail 1800 to secure the solar panel module 102 to the surface 104, according to an embodiment of the present disclosure. For example, the attachment mechanism 100 may be used to secure the rail 1800 to the surface 104, and in turn, the solar panel module 102 may be secured to the rail 1800. More particularly, the spacer 112 and/or the seal 114 may be disposed between the rail 1800 and the surface 104. The fastener 110 may be used to secure the rail 1800, the spacer 112, and the seal 114 to the surface 104, and thereafter, a through hole 106 may be disposed onto the fastener 110. Therein, the nut 116 may secure the solar panel module 102 to the rail.

In an embodiment, the solar panel module 102 may be secured to the rail 1800 via fasteners, brackets, connectors, mounts, snap-fit, etc. For example, in an embodiment, the rail 1800 may be secured to the surface 104 with a fastener disposed through the spacer 112 and/or the seal 114. Therein, other mounts, brackets, etc., may secure the solar panel modules 102 to the rail 1800. Moreover, although a particular orientation of the rail 1800 relative to the solar panel module 102 is shown, the rail 1800 may be oriented differently than shown. A plurality of the attachment mechanisms 100 may be used to secure the rail 1800 and/or the solar panel module 102 to the surface 104.

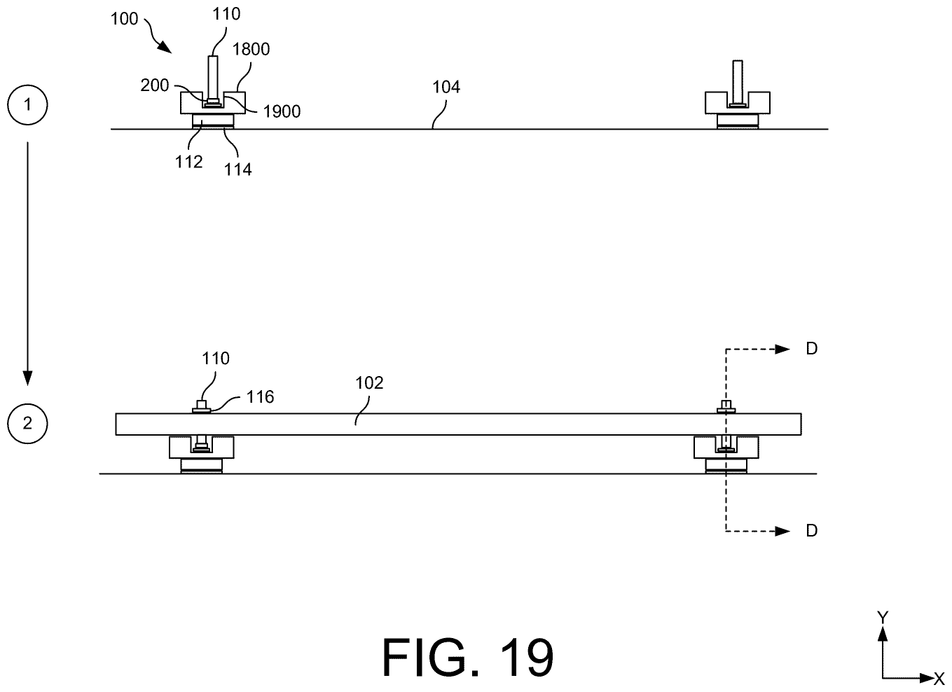

FIG. 19 illustrates an example sequence to secure the solar panel module 102 to the surface 104 using the attachment mechanism 100 and the rail 1800, according to an embodiment of the present disclosure. At “1” in FIG. 19, the fastener 110 may be at least partially disposed through the spacer 112, the seal 114, and a hole in the rail 1800, and into the surface 104. In an embodiment, the nut 200 may be threaded onto the fastener 110 and used to drive the fastener 110 into the surface 104. In an embodiment, the rail 1800 may include a channel 1900 in which the nut 200 is disposed.

At “2” in FIG. 19, the solar panel module 102 may be disposed onto the fastener 110. The solar panel module 102 may rest on a surface of the rail 1800, external to the channel 1900. Further, the nut 116 may be disposed onto the fastener 110 and tightened to secure the solar panel module 102 to the surface 104.

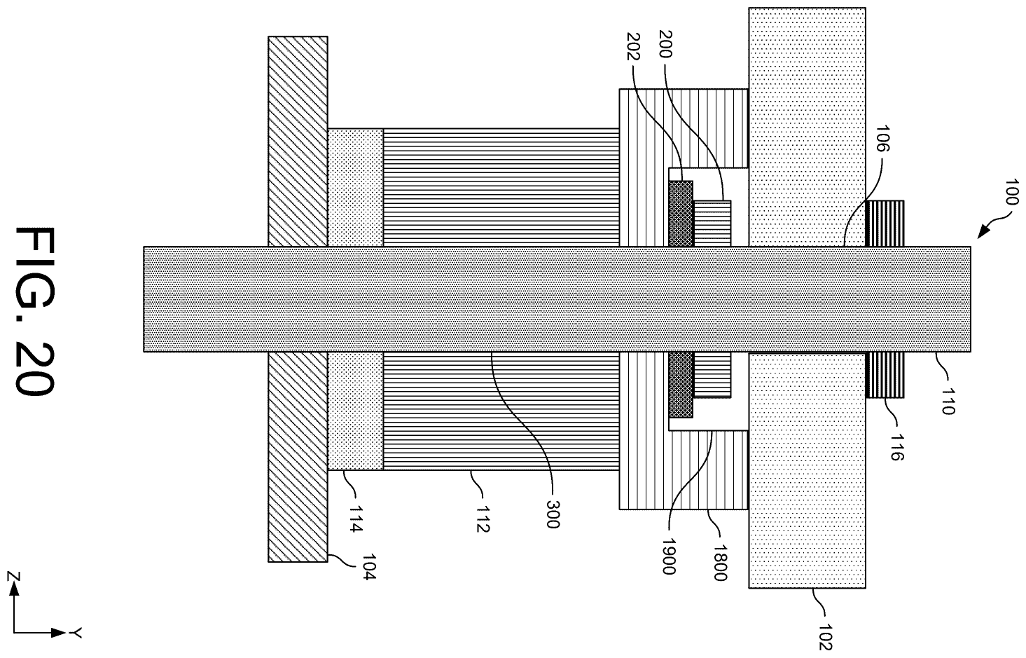

FIG. 20 illustrates a cross-sectional view of the attachment mechanism 100, the solar panel module 102, and the rail 1800, taken along line D-D of FIG. 19, according to an embodiment of the present disclosure. The fastener 110 extends through the channel 300 in the spacer 112. The fastener 110 also extends through the seal 114 and the washer 202. The fastener 110, as noted above, may be secured into the surface 104 using the nut 200 that is threaded onto the fastener 110. The nut 200 may be used to drive the fastener 110 into the surface 104 and secure the rail 1800 to the surface 104. The nut 200, as shown, may be disposed within the channel 1900 of the rail 1800. Once the fastener 110 is secured into the surface 104, the fastener 110 may be disposed through the through hole 106 in the solar panel module 102. Thus, the nut 116 may be threaded onto the fastener 110 for securing the solar panel module 102. Although not shown, the spacer 112 may include a counterbore to receive a sealant that seals against the surface 104. In such instances, the seal 114 may be omitted.

Although FIGS. 18-20 describe the attachment mechanism 100 being used in conjunction with the rail 1800 to secure the solar panel module 102 to the surface 104, other mounts, brackets, etc., may be secured to the surface 104 using the attachment mechanism 100. For example, the fastener 110 may be used to secure a mount and the spacer 112 to the surface 104. As such, the solar panel module 102 may be secured to the mount, for example, via fasteners, snap-fits, etc.

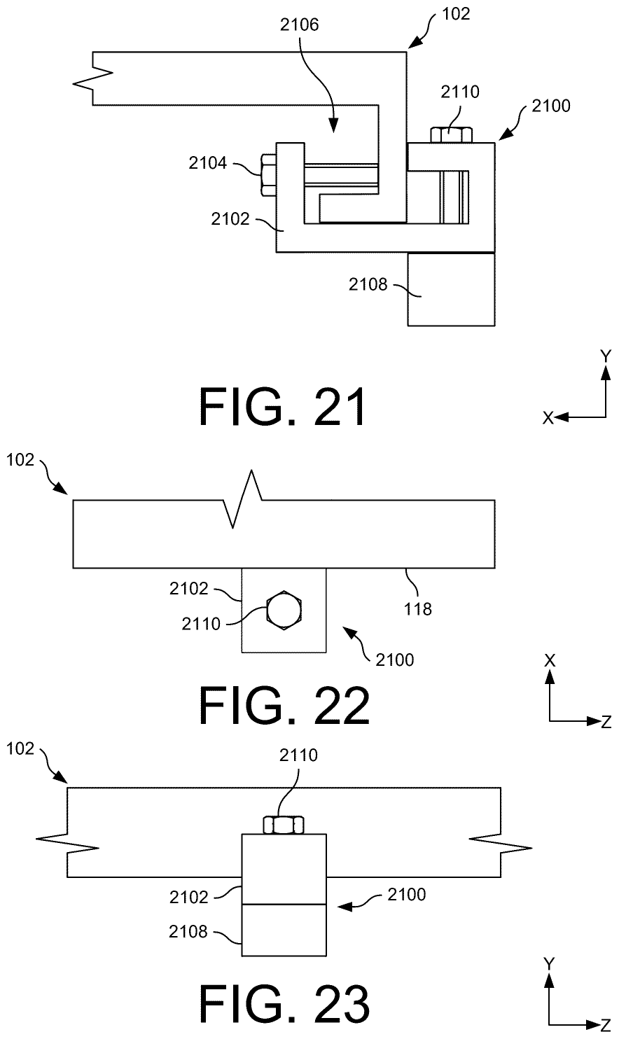

FIG. 21 illustrates an attachment mechanism 2100 for securing the solar panel module 102 to the surface 104, according to an embodiment of the present disclosure. In an embodiment, the attachment mechanism 2100 may include, or be used in conjunction with, a connector 2102. For example, the connector 2102 may be secured to the solar panel module 102 (or a frame thereof) via a fastener 2104. In an embodiment, the connector 2102 may include a receptacle 2106 into which the solar panel module 102 is at least partially disposed, and thus, the fastener 2104 may be fastened to secure the connector 2102 to the solar panel module 102.

Moreover, a fastener 2110 may be disposed through the connector 2102 and a spacer 2108. The fastener 2110 may be secured into the surface 104 to secure the solar panel module 102 to the surface 104. The spacer 2108 may be similar to the spacers discussed herein, such as the spacer 112. Moreover, a sealant, or seal, for example, may be disposed between the spacer 2108 and the surface 104 for creating a water-tight seal. Although the spacer 2108 and the connector 2102 are described as separate components, in an embodiment, the spacer 2108 and the connector 2102 may be integrated with one another.

FIG. 22 illustrates a top view of the attachment mechanism 2100 and the connector 2102, according to an embodiment of the present disclosure. In an embodiment, the connector 2102 may be secured to the solar panel module 102, adjacent to the perimeter 118 of the solar panel module 102. In an embodiment, the solar panel module 102 may or may not include the through holes 106. Any number of the attachment mechanisms 100 and/or the connectors 2102 may be used to secure the solar panel module 102 to the surface 104.

FIG. 23 illustrates a side view of the attachment mechanism 2100 and the connector 2102, according to an embodiment of the present disclosure. In an embodiment, the connector 2102 may be disposed along the perimeter 118, and the spacer 2108 serves to offset the solar panel module 102 from the surface 104 (e.g., in the Y-direction).

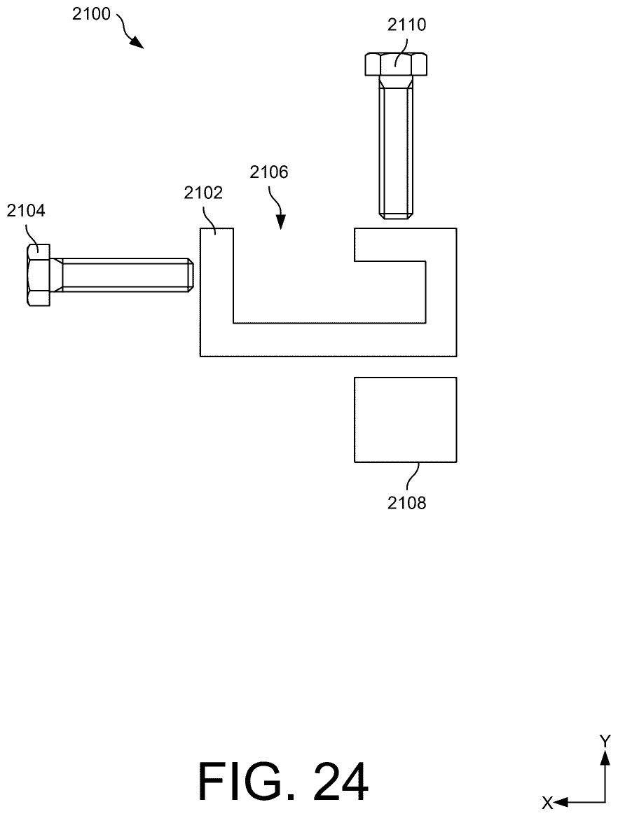

FIG. 24 illustrates an exploded view of the attachment mechanism 2100 and the connector 2102, according to an embodiment of the present disclosure. The connector 2102 may include flanges, for example, that define apertures for receiving the fastener 210 and the fastener 2110.

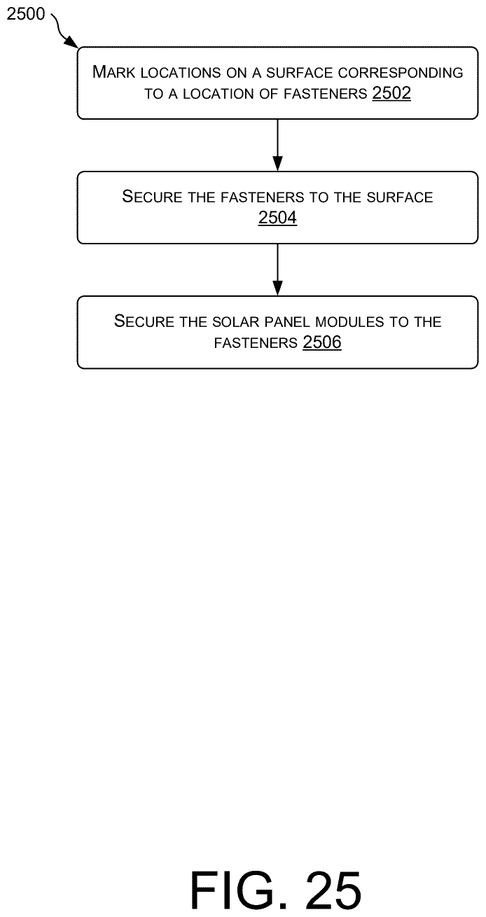

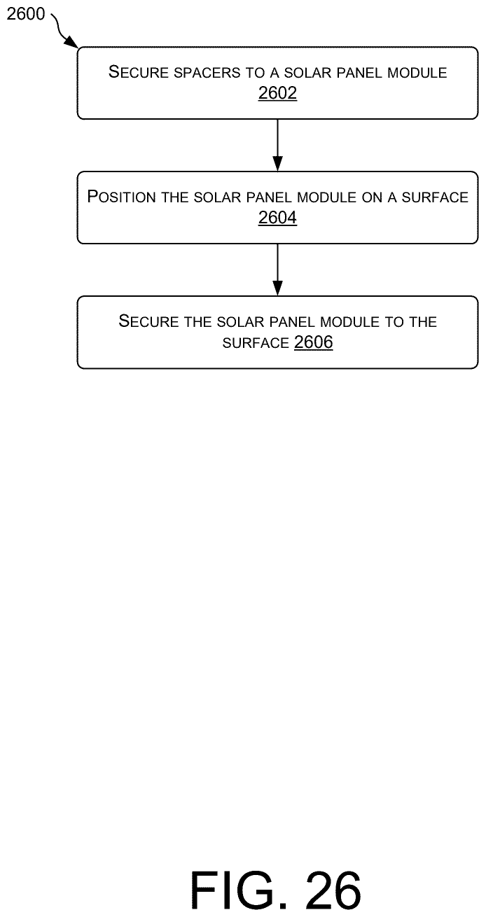

FIGS. 25 and 26 illustrate example processes in accordance with an embodiment of the disclosure. The order in which the operations are described is not intended to be construed as a limitation, and any number of the described operations may be omitted or combined in any order and/or in parallel to implement the processes. For example, some or all of the processes may be performed by one or more components in FIGS. 1-24, as described herein

FIG. 25 illustrates an example process 2500 associated with securing solar panel modules 102 to the surface 104, according to an embodiment of the present disclosure.

At 2502, the process 2500 may include marking locations on a surface corresponding to the placement of fasteners. For example, a stencil, template, etc., may be used to mark locations on the surface 104 corresponding to a location of the fasteners 110 used to secure the solar panel modules 102 to the surface 104. In an embodiment, the locations may be based on the type of the solar panel module 102, the size of the solar panel module 102, and so forth. Moreover, the locations may be such that when the solar panel module 102 is secured to the surface 104, the fasteners 110 are disposed internally to a perimeter of the solar panel module 102.

At 2504, the process 2500 may include securing the fasteners to the surface. For example, the fasteners 110 may be driven into the surface 104. In an embodiment, in addition to securing the fasteners to the surface 104, the spacers 112 and the seal 114 may be secured to the surface 104. The fasteners 110, for example, may secure the spacers 112 and the seal 114 to the surface 104. Alternatively, the seal 114 may not be used, and instead, a sealant may be at least partially disposed in the spacer 112. For example, the sealant may be injected into a cavity or counterbore of the spacer 112. As the fastener 110 is secured into the surface, the sealant may seal against the surface to prevent an ingress of liquid.

At 2506, the process 2500 may include securing the solar panel modules to the fasteners. For example, the through holes 106 of the solar panel modules 102 may be placed over, onto, etc., the fasteners 110. In an embodiment, the through holes 106 may be aligned with individual through holes of the through holes 106. Once disposed onto the fasteners 110, the nuts 116 may be threaded onto the fasteners 110 to secure the solar panel modules 102 onto the fasteners 110, and consequently, to the surface 104.

FIG. 26 illustrates an example process 2600 associated with securing solar panel modules 102 to the surface 104, according to an embodiment of the present disclosure.

At 2602, the process 2600 may include securing spacers to a solar panel module. For example, spacers (e.g., the spacers 112, the spacers 904, etc.) may be secured to the solar panel module 102. The spacers may be secured to the solar panel module 102 at locations corresponding to the through holes 106. Moreover, a plurality of the spacers may be secured to the solar panel module 102. In an embodiment, a sealant may be disposed within a channel of the spacers. For example, the sealant may be injected into a counterbore of the spacer.

At 2604, the process 2600 may include positioning the solar panel module on a surface. For example, the solar panel module 102 may be placed on the surface.

At 2606, the process 2600 may include securing the solar panel module to the surface. For example, fasteners may be disposed through the spacers and into the surface 104. In an embodiment, the fasteners may be disposed through a portion of the spacers, where a remaining amount of the spacers not including the fasteners may be used to support the solar panel module 102 above the surface.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate structures, mechanisms, or devices.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An attachment mechanism to secure a solar panel module to a surface, the attachment mechanism comprising:
a spacer including a channel, the spacer disposable adjacent to a through hole of the solar panel module, the through hole being disposed internal to a perimeter of the solar panel module;
a fastener including:
a first portion having first threads, the first portion disposable at least partially disposed through the channel, the first threads at least partially disposable into the surface to secure the spacer and the fastener to the surface, and
a second portion having second threads different than the first threads, the second portion disposable at least partially through the through hole of the solar panel module; and
a nut engageable with the second threads to secure the solar panel module to the fastener.

2. The attachment mechanism of claim 1, wherein the fastener includes a hanger bolt.

3. The attachment mechanism of claim 1, further comprising a second nut engageable with the second threads, the second nut to secure the fastener into the surface.

4. The attachment mechanism of claim 1, further comprising a seal disposable between the spacer and the surface.

5. The attachment mechanism of claim 1, wherein the channel includes a counterbore to receive a sealant.

6. The attachment mechanism of claim 1, wherein the through hole is disposed internal to solar cells of the solar panel module.

7. The attachment mechanism of claim 1, wherein the spacer is engageable with the solar panel module or within the through hole.

8. An apparatus comprising:
a spacer including a channel, the spacer being positionable adjacent to a through hole disposed in a solar panel module, the through hole being located within a perimeter of the solar panel module; and
a fastener positionable through the channel and the through hole, into a surface, to secure the solar panel module to the surface.

9. The apparatus of claim 8, wherein the spacer is at least partially positionable into the through hole.

10. The apparatus of claim 8, wherein a sealant is disposable within the channel to seal the spacer against the surface.

11. The apparatus of claim 8, wherein:
a portion of the fastener extends through the through hole; and
a nut is engageable with the portion of the fastener to secure the solar panel module to the surface.

12. The apparatus of claim 8, wherein the through hole is disposed internal to solar cells of the solar panel module.

13. The apparatus of claim 8, wherein the spacer is securable to the solar panel module.

14. The apparatus of claim 8, wherein:
the spacer includes:
a base,
a flange, and
a neck disposed between the flange and the base;
the base is disposable adjacent to a bottom surface of the solar panel module;
the flange is disposable adjacent to a top surface of the solar panel module; and
the neck is disposed through the through hole of the solar panel module.

15. An attachment for securing a solar panel module to a surface, the attachment comprising:
a first end;
a second end spaced apart from the first end; and
a channel disposed through the attachment, between the first end and the second end, the channel being disposable adjacent to a through hole in a solar panel module, the through hole being located internal to a perimeter of the solar panel module, wherein a fastener is disposable through the channel and into the surface.

16. The attachment of claim 15, wherein the attachment is at least partially disposable into the through hole.

17. The attachment of claim 15, further comprising a counterbore connected to the channel, the counterbore to receive a sealant to seal the attachment against the surface.

18. The attachment of claim 15, wherein the attachment secures a rail to the surface.

19. The attachment of claim 15, wherein a portion of the fastener is disposed through the through hole.

20. The attachment of claim 15, wherein the through hole is disposed internal to solar cells of the solar panel module.
